(19) United States
(12) Patent Application Publication
(10) Pub. No.: US 2022/0033663 A1
(43) Pub. Date: Feb. 3, 2022

(54) FLUORINE-CONTAINING DISPERSION AND METHOD OF MANUFACTURING THE SAME, AND FLUORINE-CONTAINING COMPOSITE FILM

(71) Applicant: Zhen Ding Technology Co., Ltd., Tayuan (TW)

(72) Inventors: KUAN-WEI LEE, Tayuan (TW); SZU-HSIANG SU, Taoyuan (TW); SHOU-JUI HSIANG, Tayuan (TW); PEI-JUNG WU, Taoyuan (TW); WEI-HSIN HUANG, Tayuan (TW)

(21) Appl. No.: 17/012,252

(22) Filed: Sep. 4, 2020

(30) Foreign Application Priority Data
Aug. 3, 2020 (CN) 202010769135.X

(51) Int. Cl. C09D 7/45; C09D 127/12; C09D 7/65; C09D 7/40

(52) U.S. Cl. CPC C09D 7/45; C09D 7/40; C09D 7/65; C09D 127/12

(57) ABSTRACT

A fluorine-containing dispersion is disclosed, the solid content of the fluorine-containing dispersion including a fluorine-containing polymer powder and polyimide. The fluorine-containing polymer powder has a mass ratio greater than 85% in the solid content, and the polyimide has a mass ratio less than 15% in the solid content. An average particle size of the fluorine-containing polymer powder is less than or equal to 3 μm. A method of preparing the fluorine-containing dispersion, and a fluorine-containing composite film made using the fluorine-containing dispersion are also disclosed.

### FIELD

The subject matter herein generally relates to a fluorine-containing dispersion, a method of manufacturing the same, and a fluorine-containing composite film.

### BACKGROUND

A conventional release film may not be resistant to high temperature, it may shrink and lose the ability to release at high temperature. Thus, such release films may not be used in high temperature process. For example, such release films may not be used to manufacture a polyimide film.

To manufacture the polyimide film, a polyamic acid solution is first coated on a steel belt, and dried to obtain a polyamic acid film. Then, the polyamic acid film is cured at high temperature, both sides of the polyamic acid film being clamped to stretch the polyamic acid film along a transverse direction (TD) and along a machine direction (MD). The force of stretching, the thickness of the film, and the shrinkage force of the film generated during the curing must be carefully controlled. A difference in strength of the film along the MD and TD directions cannot be too large because the polyamic acid film may collapse and adhere to the clamp at high temperatures. As such, conventional stretching processes may not be used to manufacture a thermoplastic polyimide film.

### BRIEF DESCRIPTION OF THE DRAWINGS

Implementations of the present disclosure will now be described, by way of example only, with reference to the attached figures.

FIG. 1 is a diagrammatic view of an embodiment of a fluorine-containing composite film according to the present disclosure.

FIG. 2 is a diagrammatic view showing a manufacturing layout for a polymer film according to one embodiment of the present disclosure.

FIG. 3 is a diagrammatic view showing a manufacturing layout for a polymer film according to another embodiment of the present disclosure.

FIG. 4 is a flowchart of a method for manufacturing a fluorine-containing dispersion according to the present disclosure.

FIG. 5 is a flowchart of an embodiment of a method for manufacturing a polyimide solution.

FIG. 6 is a flowchart of an embodiment of a method for manufacturing a fluorine-containing composite film.

FIG. 7 is a flowchart of an embodiment of a method for manufacturing a polymer film.

FIG. 8 is a flowchart of an embodiment of a method for manufacturing a polyimide film.

FIG. 9 is a flowchart of another embodiment of a method for manufacturing a polyimide film.

### DETAILED DESCRIPTION

It will be appreciated that for simplicity and clarity of illustration, where appropriate, reference numerals have been repeated among the different figures to indicate corresponding or analogous elements. In addition, numerous specific details are set forth to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to illustrate details and features of the present disclosure better. The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising” when utilized, means “including, but not necessarily limited to”; it specifically indicates open-ended inclusion or membership in the so-described combination, group, series, and the like.

In an embodiment, a fluorine-containing dispersion is disclosed, comprising a fluorine-containing polymer powder, a first solvent, and a polyimide solution. An average particle size of the fluorine-containing polymer powder is less than or equal to 3 μm. The polyimide solution comprises polyimide and a second solvent. The fluorine-containing polymer powder and the polyimide form a solid content of the fluorine-containing dispersion. The fluorine-containing polymer powder has a mass ratio greater than 85% in the solid content of the fluorine-containing dispersion. The polyimide has a mass ratio less than 15% in the solid content of the fluorine-containing dispersion.

In an embodiment, the solid content of the fluorine-containing dispersion is in a mass ratio from 40% to 50%.

In an embodiment, the fluorine-containing polymer powder comprises a material selected from a group consisting of polyfluoroethylene, perfluorocarbone oxytocin, plesser propylene, trifluoroethylene, ethylene-triflonon, polyfluoroethylene, and any combination thereof.

In an embodiment, each of the first solvent and the second solvent is a polar solvent. The polar solvent may be N-methyl pyridoxerane (NMP), dimethyl acetylamide (DMAC), or 1,4-butyleste (GBL).

In an embodiment, the first solvent and the second solvent are NMP.

In an embodiment, the fluorine-containing dispersion also comprises an interface active agent. The interface active agent may be, but is not limited to, polyether polyamide, polyether, polyester polyamide, polyurethane, and sodium polychlorate salt. The interface active agent causes the fluorine-containing polymer powder to be uniformly dispersed in the first solvent.

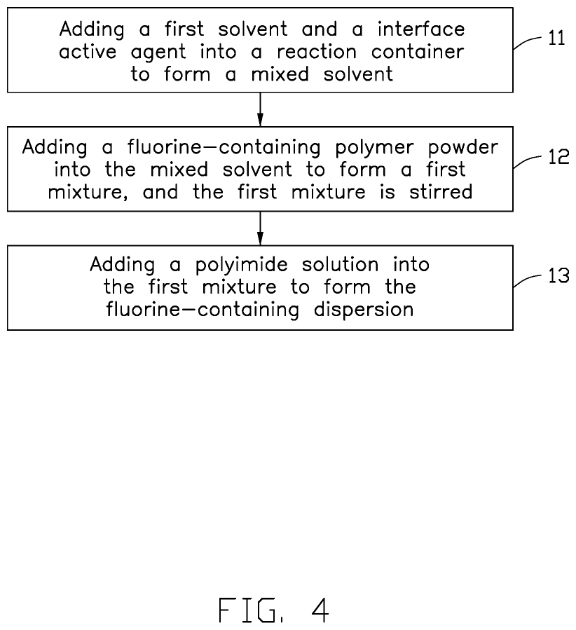

FIG. 4 illustrates a flowchart of a method for manufacturing the fluorine-containing dispersion according to an embodiment. The method for manufacturing the fluorine-containing dispersion is provided by way of example, as there are a variety of ways to carry out the method. The method can begin at block 11.

Block 11, the first solvent and the interface active agent are added into a reaction container to form a mixed solvent. The mixed solvent is stirred.

In an embodiment, the first solvent is a polar solvent, which may be N-methyl pyroxane (NMP).

In an embodiment, the interface active agent may be, but is not limited to, polyether polyamide, polyether, polyester polyamide, polyurethane, and sodium polychlorate salt.

Block 12, the fluorine-containing polymer powder is added into the mixed solvent to form a first mixture. The first mixture is stirred.

In an embodiment, the fluorine-containing polymer powder is added into the mixed solvent in batches, and is stirred for about 0.5 h to 24 h, which evenly disperses the fluorine-containing polymer powder in the mixed solvent.

In an embodiment, the fluorine-containing polymer powder comprises a material selected from a group consisting of polytetrafluoroethylene (PTFE), perfluoronotenic oxygen, polyfluopropylene (FEP), trifluoroethylene (CTFE), ethylene-trifluoroethylene (ECTFE), polyfluoroethylene (PVDF), and any combination thereof.

In an embodiment, the fluorine-containing polymer powder is perfluoroase oxygen (PFA).

In an embodiment, the average particle size of the fluorine-containing polymer powder is less than or equal to 3 μm. In another embodiment the average particle size of the fluorine-containing polymer powder is 0.1 μm to 3 μm.

Block 13, a polyimide solution is added into the first mixture to form the fluorine-containing dispersion.

In an embodiment, the fluorine-containing polymer powder and polyimide form the solid content of the fluorine-containing dispersion. The fluorine-containing polymer powder has a mass ratio greater than 85% in the solid content of the fluorine-containing dispersion. The polyimide has a mass ratio less than 15% in the solid content of the fluorine-containing dispersion.

Assuming the total mass ratio of polyimide, PFA powder, first solvent, and second solvent is 100%, the solid content of the fluorine-containing dispersion is in a mass ratio from 40% to 50%. A viscosity of the fluorine-containing dispersion is in a range from 500 CPS to 1500 CPS.

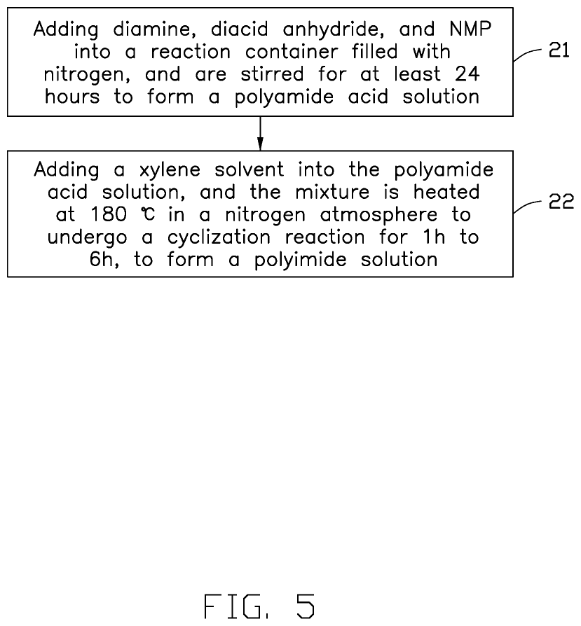

FIG. 5 illustrates a flowchart of a method for manufacturing the polyimide solution according to an embodiment. The method for manufacturing the polyimide solution is provided by way of example, as there are a variety of ways to carry out the method. The method can begin at block 21.

Block 21, diamine, diacid anhydride, and NMP are added into the reaction container filled with nitrogen, and are stirred for at least 24 hours to form a polyamic acid solution.

In an embodiment, a solid content of the polyamic acid solution is in a mass ratio of 20% to 25%.

In an embodiment, a molar ratio of diamine to the diacid anhydride is 1:1.

In an embodiment, the diamine is 2-2-double (3-amino-4-hydroxyl) hexfluoropropropane (6FAP). The weight of the diamine is 20 g to 40 g. In another embodiment, the weight of the diamine is 24 g to 34 g.

In an embodiment, the diacid anhydride is 4,4′-(hexafluopropyl) diphthaphylated acidin (6FDA). The weight of the diacid anhydride is 40 g to 55 g.

Block 22, a xylene solvent is added into the polyamic acid solution. The mixture is heated at 180° C. in a nitrogen atmosphere to undergo a cyclization reaction for 1 h to 6 h, to form the polyimide solution.

In an embodiment, the reaction process in the polyimide solution is as follows.

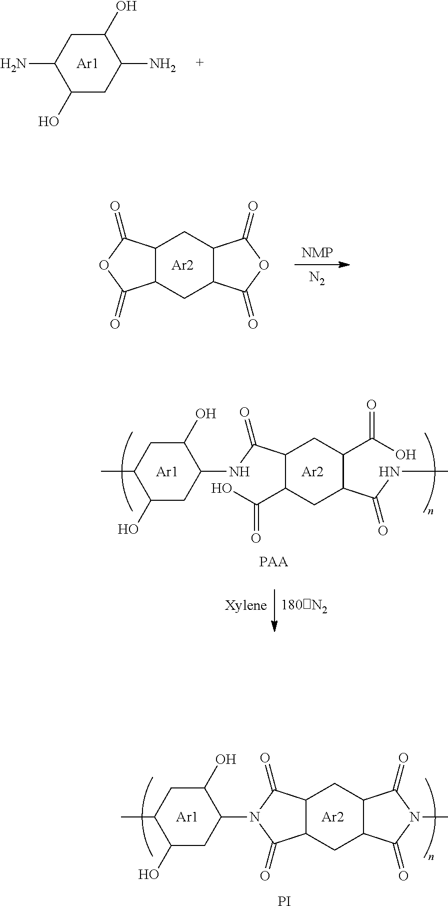

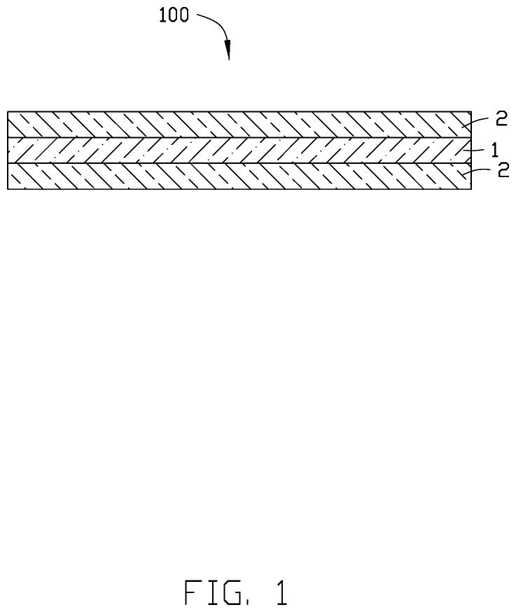

Referring to FIG. 1, a fluorine-containing composite film 100 is provided, which includes a carrier film 1 and a fluorine-containing film 2. The fluorine-containing film 2 is located on at least one surface of the carrier film 1. The fluorine-containing film 2 is formed by coating the fluorine-containing dispersion on the carrier film 1 and then heating the fluorine-containing dispersion.

In an embodiment, the carrier film 1 is a polyimide film, and a thickness of the carrier film 1 is in a range from 125 μm to 225 μm. The large thickness of the polyimide film can improve the stiffness and toughness of the fluorine-containing composite film 100.

In an embodiment, a thickness of the fluorine-containing film 2 is in a range from 3 μm to 6 μm.

The fluorine-containing film 2 comprises the fluorine-containing polymer powder and polybenzoxazole. The release force of the fluorine-containing composite film 100 can be controlled by adjusting the amount of fluorine-containing polymer powder and polybenzoxazole. The fluorine-containing polymer powder has a mass ratio greater than 85% in the fluorine-containing composite film 100. The polybenzoxazole has a mass ratio less than 15% of the fluorine-containing composite film 100. The fluorine-containing polymer powder in fluorine-containing film 2 is easily melted at high temperature to form a film.

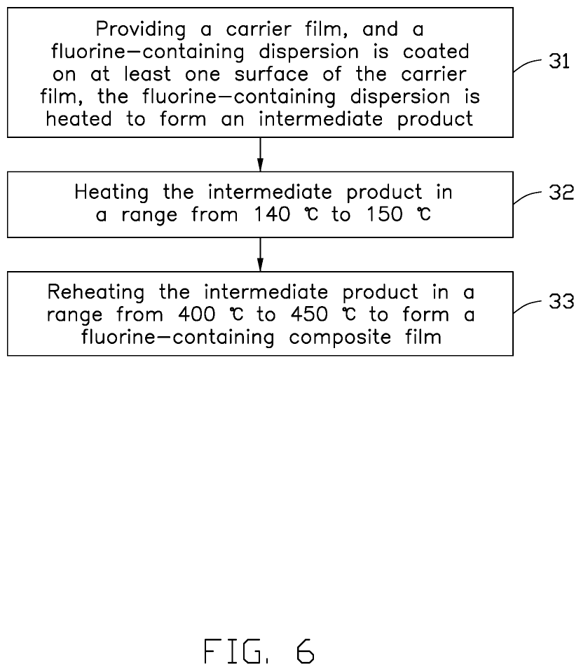

FIG. 6 illustrates a flowchart of a method for manufacturing the fluorine-containing composite film 100 according to an embodiment. The method for manufacturing the fluorine-containing composite film 100 is provided by way of example, as there are a variety of ways to carry out the method. The method can begin at block 31.

Block 31, a carrier film 1 is provided. The fluorine-containing dispersion is coated on at least one surface of the carrier film 1. The fluorine-containing dispersion is heated to form an intermediate product.

In an embodiment, the carrier film 1 is a polyimide film.

Block 32, the intermediate product is heated at a first temperature.

In an embodiment, the first temperature is in a range from 140° C. to 150° C.

Block 33, the intermediate product after being heated is sintered at a second temperature to form the fluorine-containing composite film 100.

In an embodiment, the second temperature is in a range from 400° C. to 450° C.

The polyimide solution is rearranged at high temperatures (that is, thermally rearranged), to cause the diamine structure in polyimide to convert to polybenzoxazole. The reaction process of the polyimide solution is as follows.

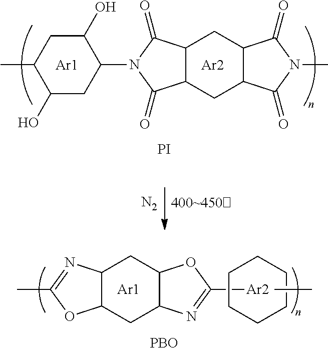

The polybenzoxazole (PBO) is a resin which has good thermal properties, mechanical properties, and chemical resistance. The structure of PBO is similar to that of polyimide, but the polarity of PBO is lower than that of polyimide. The polybenzoxazole in the fluorine-containing film 2 changes the release force of the fluorine-containing composite film 100, and improves a bonding strength between the fluorine-containing film 2 and the carrier film 1.

The fluorine-containing polymer powder is melted at high temperature. The melted fluorine-containing polymer powder has good film-forming properties, and improves the stability of the fluorine-containing film 2.

The polyimide film in the fluorine-containing composite film 100 is thick, and thus the polyimide film has high stiffness and toughness. Block 33 process can be carried out by suspended roll-to-roll process. Block 33 can also be carried out in a cyclic furnace. The large thickness of the polyimide film can reduce the curling of the polyimide film during the heating processes. Block 33 has no requirement for oxygen content, which protects the environment. The release force of the fluorine-containing composite film 100 can be controlled by adjusting the amount of fluorine-containing polymer powder and polybenzoxazole. Moreover, the method for manufacturing the fluorine-containing composite film 100 can be used to manufacture a thermoplastic polyimide film. The amount of fluorine-containing polymer powder and polybenzoxazole can be controlled by adjusting the amount of fluorine-containing polymer powder and polyimide when preparing the fluorine-containing dispersion.

The fluorine-containing film 2 is coated on at least one side of the carrier film 1. The manufacturing efficiency of the polymer film is improved when each side of the carrier film 1 is coated with the fluorine-containing film 2. The fluorine-containing composite film 100 is a high-temperature material (Td>500° C.), which can be used in high temperature process. The fluorine-containing composite film 100 is recyclable.

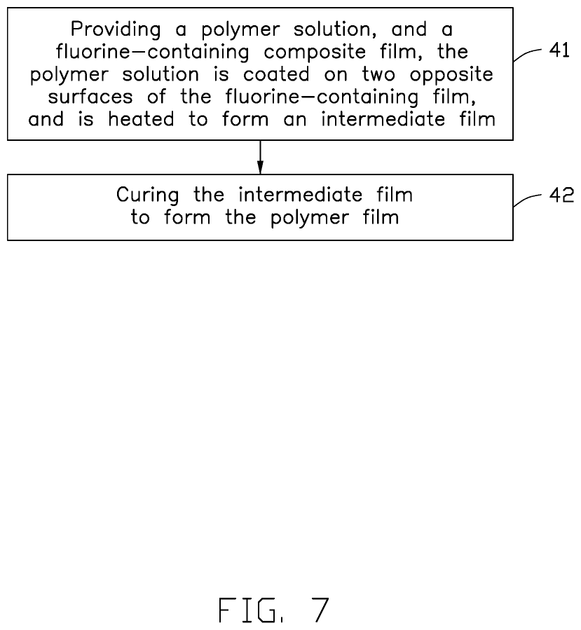

FIG. 7 illustrates a flowchart of a method for manufacturing the polymer film according to an embodiment. The method for manufacturing the polymer film is provided by way of example, as there are a variety of ways to carry out the method. The method can begin at block 41.

Block 41, a polymer solution and the fluorine-containing composite film 100 are provided. The polymer solution is coated on two opposite surfaces of the fluorine-containing film 2, and is heated to form an intermediate film.

Block 42, the intermediate film is cured to form the polymer film.

The polymer solution may be, but is not limited to, polyimide solution, polyamic acid solution, and polyester solution.

In an embodiment, the polymer solution is polyamic acid solution.

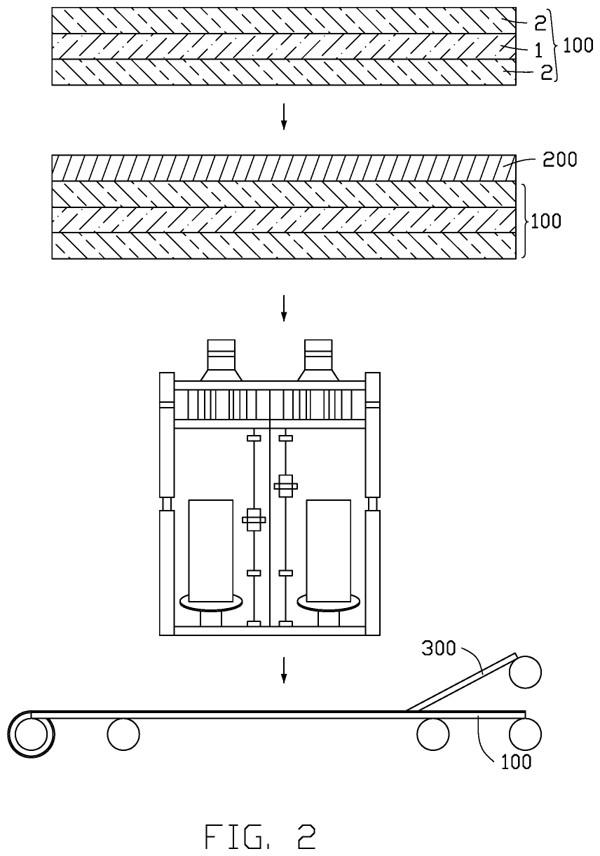

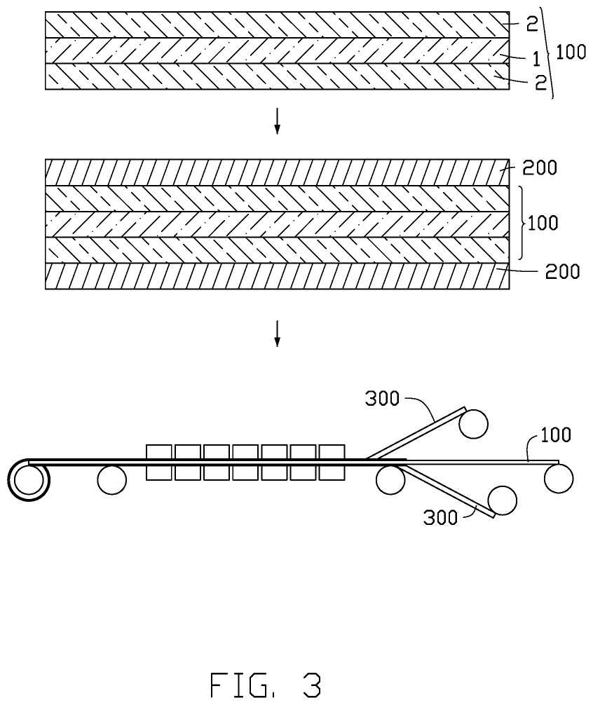

FIG. 2 and FIG. 3 show two embodiments of manufacturing the polymer film according to the present disclosure. In one embodiment, the whole intermediate film roll is placed into the oven to form the polymer film. In this embodiment, only one side of the fluorine-containing composite film 100 is coated by the polymer film. In another embodiment, different parts of the intermediate film are successively transported through the suspended RTR oven to form the polymer film. In this embodiment, two sides of the fluorine-containing composite film 100 are coated by the polymer films, which can improve the manufacturing efficiency of the polymer film. The polymer film with a small thickness can be formed by these two embodiments.

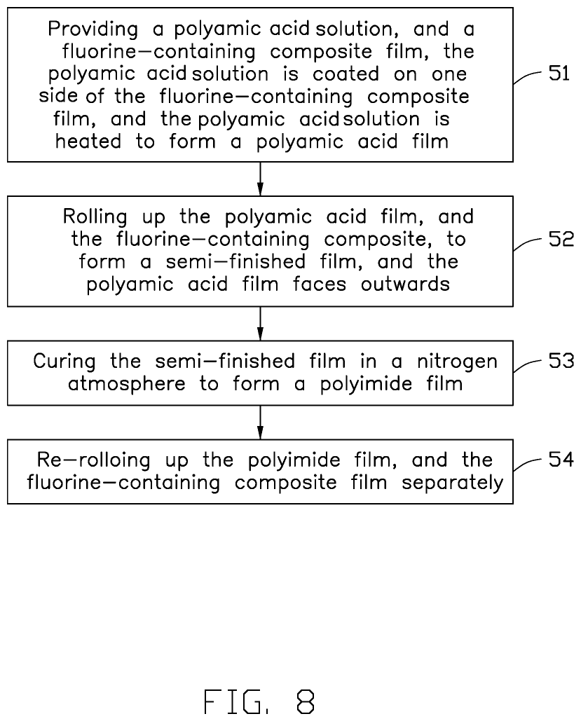

FIG. 8 illustrates a flowchart of a method for manufacturing the polyimide film 300 according to an embodiment. The method for manufacturing the polyimide film 300 is provided by way of example, as there are a variety of ways to carry out the method. The method can begin at block 51.

Block 51, referring to FIG. 2, a polyamic acid solution, and the fluorine-containing composite film 100 are provided. The polyamic acid solution is coated on one side of the fluorine-containing composite film 100. The polyamic acid solution is heated to form a polyamic acid film 200.

Block 52, the polyamic acid film 200, and the fluorine-containing composite film 100 are rolled up to form a semi-finished film. The polyamic acid film 200 faces outwards.

When each side of the carrier film 1 is coated with the fluorine-containing film 2, the polyamic acid film 200 cannot adhere to the fluorine-containing composite film 100 without the polyamic acid film 200.

Block 53, the semi-finished film is cured in a nitrogen atmosphere to form the polyimide film 300.

Block 54, the polyimide film 300 and the fluorine-containing composite film 100 are re-rolled up separately.

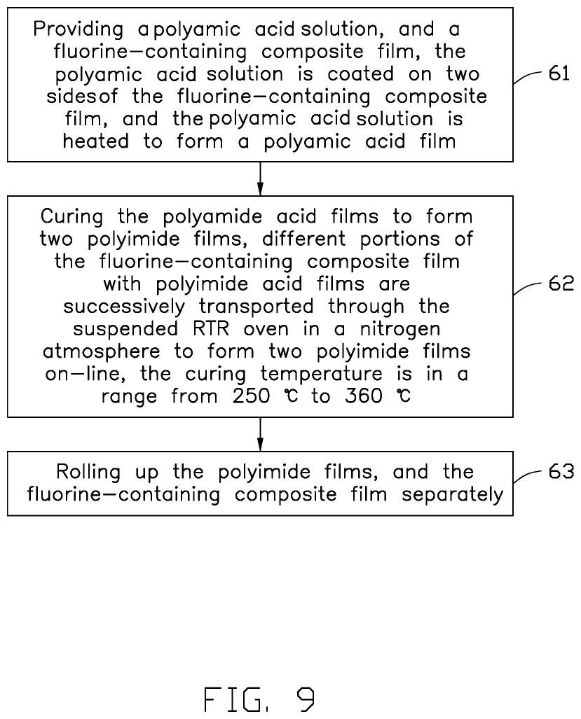

FIG. 9 illustrates another flowchart of a method for manufacturing the polyimide film 300 according to an embodiment. The method for manufacturing the polyimide film 300 is provided by way of example, as there are a variety of ways to carry out the method. The method can begin at block 61.

Block 61, referring to FIG. 3, a polyamic acid solution and the fluorine-containing composite film 100 are provided. The polyamic acid solution is coated on two sides of the fluorine-containing composite film 100. The polyamic acid solution is heated to form a polyamic acid film 200.

Block 62, the polyamic acid films 200 are cured to form the polyimide films 300. Different portions of the fluorine-containing composite film 100 with polyamic acid films 200 are successively transported through the suspended RTR oven in a nitrogen atmosphere to form the polyimide films 300 on-line. The curing temperature is 250° C. to 360° C.

Block 63, the polyimide films 300, and the fluorine-containing composite film 100 are re-rolled up separately.

Two rolls of polyimide films 300 can be produced at the same time, which increases the manufacturing efficiency of the polyimide film 300.

The fluorine-containing composite film 100 has a high resistance to high temperatures, high temperatures being used to manufacture the polyimide film 300. The polyamic acid film does not need to be stretched along a transverse direction (TD) and a machine direction (MD) during the process of manufacturing the polyimide film 300.

### Synthesis Example 1

Diamine (6FAP, 33.89 g) and diacid anhydride (6FDA, 41.11 g) were added into a 500 ml container to form a mixture. The molar ratio of diamine and diacid anhydride was 1:1. The solvent was NMP (225 g). The solid content of the mixture was in a mass ratio of 20% to 25%. The mixture was stirred in a nitrogen atmosphere for 24 hours. Xylene (45 g) was added in the mixture. Then, the mixture with xylene was heated to 180° C. The mixture with the xylene was stirred for 6 hours in a nitrogen atmosphere to form the polyimide solution.

### Synthesis Example 2

Diamine (3,3′-dihydroxythyl neamine, HAB, 24.55 g) and diacid anhydride (6FDA, 50.45 g) were added into a 500 ml container to form a mixture. The molar ratio of diamine and diacid anhydride was 1:1. The solvent was NMP (225 g). The solid content of the mixture was in a mass ratio of 20% to 25%. The mixture was stirred in a nitrogen atmosphere for 24 hours. Xylene (45 g) was added in the mixture. Then the mixture with xylene was heated to 180° C. The mixture with the xylene was stirred for 6 hours in a nitrogen atmosphere to form the polyimide solution.

### Example 1

NMP (45 g) and a interface active agent (5 g) were added into a 500 mL container to form a mixed solvent. Then the PFA (particle size <3 μm, 50 g) was slowly added into the mixed solvent, and was stirred for about 24 h, to form the fluorine-containing dispersion without polyimide solution.

### Example 2

The fluorine-containing dispersion without polyimide solution (30.4 g) obtained by Example 1 was added into a 100 mL container. The polyimide solution (3.2 g) obtained by synthetic example 1 was slowly added into the fluorine-containing dispersion without polyimide solution, and was stirred for about 24 hours to form the fluorine-containing dispersion.

### Example 3

The fluorine-containing dispersion without polyamide solution (28.8 g) obtained by Example 1 was added into a 100 mL container. The polyimide solution (6.4 g) obtained by synthetic example 1 was slowly added into the fluorine-containing dispersion without polyimide solution, and was stirred for about 24 hours to form the fluorine-containing dispersion.

### Example 4

The fluorine-containing dispersion without polyimide solution (27.2 g) obtained by Example 1 was added into a 100 mL container. The polyimide solution (9.6 g) obtained by synthetic example 1 was slowly added into the fluorine-containing dispersion, and was stirred for about 24 hours to form the fluorine-containing dispersion.

### Comparative Example 1

The difference between Comparative Example 1 and Example 1 was that the average particle size of the PFA was 4 μm to 6 μm.

### Comparative Example 2

The difference between Comparative Example 2 and Example 2 was that the fluorine-containing dispersion (30.4 g) obtained by comparative example 1 was used.

### Comparative Example 3

The difference between Comparative Example 3 and Example 2 was that the heating temperature was 350° C.

### Comparative Example 4

The difference between Comparative Example 4 and Example 2 was that the polyimide solution (3.2 g) was obtained by synthetic example 2 was used.

### Comparative Example 5

The fluorine-containing dispersion without polyimide solution (25.6 g) obtained by Example 1 was added into a 100 mL container. The polyimide solution (12.8 g) obtained by synthetic example 1 was slowly added into the fluorine-containing dispersion, and was stirred for about 24 hours to form the fluorine-containing dispersion.

Performances of the substances of embodiments 1-4 and the comparative example 1-5 are shown in Table 1.

TABLE 1

| | | | | | Comparative | Comparative | Comparative | Comparative | Comparative |
|---|---|---|---|---|---|---|---|---|---|
| | Example 1 | Example 2 | Example 3 | Example 4 | example 1 | example 2 | example 3 | example 4 | example 5 |
| PFA | 100 wt. % | 95 wt. % | 90 wt. % | 85 wt. % | — | 0 | 95 wt. % | 95 wt. % | 80 wt. % |
| (3 μm) | | | | | | | | | |
| PFA | — | — | — | — | 100 wt. % | 95 wt. % | — | — | — |
| (4 μm to 6 | | | | | | | | | |
| μm) | | | | | | | | | |
| Synthesis | — | 5 wt. % | 10 wt. % | 15 wt. % | — | 5 wt. % | 5 wt. % | — | 20 wt. % |
| example 1 | | | | | | | | | |
| Synthesis | — | — | — | — | — | — | — | 5 wt. % | — |
| example 2 | | | | | | | | | |
| Curing | 450 | 450 | 450 | 450 | 450 | 450 | 350 | 450 | 450 |
| temperature | | | | | | | | | |
| (° C.) | | | | | | | | | |
| Film- | PASS | PASS | PASS | PASS | NG | NG. | NG | NG | NG |
| forming | | | | | cannot be | Cannot be | phase | phase | phase |
| property | | | | | filmed | filmed | separation | separation | separation |
| (3-5 μm) | | | | | | | | | |
| Release | 0.017 | 0.043 | 0.073 | 0.098 | — | — | — | — | — |
| (kgf/cm) | | | | | | | | | |

The ratio of the PFA powder in Table 1 is calculated by a mass ratio of the PFA powder in the solid content of the fluorine-containing dispersion, and the ratio of the polyimide in Table 1 is calculated by a mass ratio of the polyimide in the solid content of the fluorine-containing dispersion.

The average particle size of fluorine-containing polymer powder was tested based on the ASTM D1210 standard.

The release force was tested based on the ASTM D3330 standard.

The release force was tested at room temperature. The roller pressure is 4.51b, 180° C., 300 mm/min peel. The standard sample is East Japan 31B.

From Table 1, the size of PFA particle needs to be less than or equal to 3 μm in the fluorine-containing dispersion compared with Example 1 and Comparative Example 1. The fluorine-containing dispersion is prone to sedimentation if the size of PFA particle is greater than 3 μm. The thickness of the film on the carrier film is also not uniform. The PFA particle will not melt completely if the average particle size is greater than 3 μm, which may affect the film-forming properties of the fluorine-containing composite film 100.

From Examples 1-4, the release force of the fluorine-containing composite film can be controlled by adjusting the mass ratio of polyimide solution and PFA powder. The release force of the fluorine-containing composite film is larger when the amount of polyimide solution is increased. This is because the polyimide solution is thermally rearranged at high temperature. The diamine structure in polyimide converts to polybenzoxazole (BPO) at high temperatures. There are differences between the polarities of BPO and PFA. BPO and PFA all have good thermal properties (Td 5%>500° C.), suitable for high temperature processes.

From Example 2 and Comparative Example 2, the PFA particles are agglomerated in the fluorine-containing dispersion of comparative example 2. This is because the size of PFA particle is too large, the PFA particle is prone to sedimenting in the fluorine-containing dispersion.

From Example 2 and Comparative Example 3, the polyimide solution of synthetic example 1 has hydroxyls (—OH). Hydroxyl is a polar hydropower group. Thermal rearrangement does not happen when the fluorine-containing dispersion is dried at 350° C., which is a lower temperature than the rearrangement temperature of the polyimide solution. The polarity difference between polyimide solution and PFA in comparative example 3 is so large that the PFA particles are sedimented in the fluorine-containing dispersion. The phase separation occurs during the manufacture of the fluorine-containing composite film.

From Example 2 and Comparative Example 4, the phase separation occurs during the manufacture of the fluorine-containing composite film formed by coating the fluorine-containing dispersion of comparative example 4. The reason is that the diamine (HAB) in synthesis Example 2 contains no fluorine, reducing the compatibility between the polyimide and the PFA.

The phase separation occurs during the manufacture of the fluorine-containing composite film obtained by coating the fluorine-containing dispersion of Comparative Example 5. The test of release force of the fluorine-containing composite film is a failure. The reason is that the weight of polyimide in Comparative Example 5 is so large that the mass ratio of BPO which is formed by polyimide at high temperature is over 15%. The difference of polarity between the PFA and the BPO is so large that the PFA and the BPO are separated. In addition, the BPO will aggregate when the mass ratio of the BPO is greater than 15%, which causes the failure of homogeneous film formation of fluorine-containing composite film at high temperatures.

In summary, the fluorine-containing composite film has a high resistance to high temperatures, high temperatures being used to manufacture the polymer film. The release force of the fluorine-containing composite film can be controlled by adjusting the amount of fluorine-containing polymer powder and polybenzoxazole. The different release force of the fluorine-containing composite film are suitable for manufacturing different polymer films. The method for manufacturing the polyimide film can be used to manufacture a thermoplastic polyimide film. Two sides of the fluorine-containing composite film are coated by the polymer films, which can improve the manufacturing efficiency of the polymer film. Each side of the fluorine-containing composite film has the release force, the polymer solution cannot adhere to the fluorine-containing composite film without the polymer solution. The polyimide film in the fluorine-containing composite film is thick, and thus the polyimide film has high stiffness and toughness. Sintering process can be carried out by suspended roll-to-roll process. Sintering process can also be carried out in a cyclic furnace. The large thickness of the polyimide film can reduce the curling of the polymer film during the heating processes. The polyamic acid film does not need to be stretched along a transverse direction (TD) and a machine direction (MD) during the process of manufacturing the polyimide film. Sintering process has no requirement for oxygen content, which protects the environment. The fluorine-containing composite film is recyclable, which can reduce the cost for manufacturing the polymer film.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A fluorine-containing dispersion, comprising:
a fluorine-containing polymer powder;
a polyimide; and
a solvent;
wherein the fluorine-containing polymer powder and the polyimide form a solid content of the fluorine-containing dispersion, the fluorine-containing polymer powder has a mass ratio greater than 85% in the solid content, the polyimide has a mass ratio less than 15% in the solid content; an average particle size of the fluorine-containing polymer powder is less than or equal to 3 μm.

2. The fluorine-containing dispersion of claim 1, wherein the solid content has a mass ratio from 40% to 50% in the fluorine-containing dispersion.

3. The fluorine-containing dispersion of claim 1, wherein the fluorine-containing polymer powder comprises a material selected from a group consisting of polytetrafluoroethylene, perfluoronotenic oxygen, polyfluopropylene, trifluoroethylene, ethylene-trifluoroethylene, polyfluoroethylene, and any combination thereof.

4. The fluorine-containing dispersion of claim 1, wherein the solvent comprises at least one of N-methyl pyridoxerane, dimethyl acetylamide, and 1,4-butyleste.

5. The fluorine-containing dispersion of claim 1, wherein a viscosity of the fluorine-containing dispersion is in a range from 500 CPS to 1500 CPS.

6. A method of preparing a fluorine-containing dispersion, comprising:
providing a first mixture, the first mixture comprising a fluorine-containing polymer powder, wherein an average particle size of the fluorine-containing polymer powder is less than or equal to 3 μm; and
adding a polyimide solution in the first mixture to form a fluorine-containing dispersion, the polyimide solution comprising polyimide;
wherein the fluorine-containing polymer powder and the polyimide form a solid content of the fluorine-containing dispersion, the fluorine-containing polymer powder has a mass ratio greater than 85% in the solid content, and the polyimide has a mass ratio less than 15% in the solid content.

7. The method of claim 6, wherein the solid content has a mass ratio from 40% to 50% in the fluorine-containing dispersion.

8. The method of claim 6, wherein the fluorine-containing polymer powder comprises a material selected from a group consisting of polytetrafluoroethylene, perfluoronotenic oxygen, polyfluopropylene, trifluoroethylene, ethylene-trifluoroethylene, polyfluoroethylene, and any combination thereof.

9. The method of claim 6, wherein a viscosity of the fluorine-containing dispersion is in a range from 500 CPS to 1500 CPS.

10. A fluorine-containing composite film, comprising:
a carrier film; and
a fluorine-containing film disposed on at least one surface of the carrier film;
wherein the fluorine-containing film comprises a fluorine-containing polymer powder and polybenzoxazole, the fluorine-containing polymer powder has a mass ratio greater than 85% in the fluorine-containing composite film, and the polybenzoxazole has a mass ratio less than 15% in the fluorine-containing composite film.

11. The fluorine-containing composite film of claim 10, wherein the carrier film is a polyimide film.

12. The fluorine-containing composite film of claim 11, wherein a thickness of the carrier film is in a range from 125 μm to 225 μm.

13. The fluorine-containing composite film of claim 10, wherein a thickness of the fluorine-containing film is in a range from 3 μm to 6 μm.

14. The fluorine-containing composite film of claim 10, wherein the fluorine-containing polymer powder comprises a material selected from a group consisting of polytetrafluoroethylene, perfluoronotenic oxygen, polyfluopropylene, trifluoroethylene, ethylene-trifluoroethylene, polyfluoroethylene, and any combination thereof.
